(19) United States
(12) Patent Application Publication
(10) Pub. No.: US 2026/0256320 A1
(43) Pub. Date: Sep. 3, 2026

(54) FLOUR SIFTING DEVICE

(71) Applicant: Franke Technology and Trademark Ltd, Hergiswil (CH)

(72) Inventors: Mark Zheng, Heshan City Guangdong (CN); Danny HUANG, Heshan City Guangdong (CN); Bruce LI, Heshan City Guangdong (CN)

(73) Assignee: Franke Technology and Trademark Ltd, Hergiswil (CH)

(21) Appl. No.: 18/718,152

(22) PCT Filed: Dec. 16, 2022
(86) PCT No.: PCT/EP2022/086440

§ 371 Date: Jun. 10, 2024

(30) Foreign Application Priority Data
Dec. 22, 2021 (CN) 202123269840.2
Sep. 26, 2022 (CN) 202222566490.4

(51) Int. Cl. A47J 43/22; B07B 1/20; B07B 1/42

(52) U.S. Cl. CPC A47J 43/22; B07B 1/20; B07B 1/42

(57) ABSTRACT

A flour sifting device having: a rack; a flour accommodating basin with a first flour outlet at the bottom thereof; a flour sifting tank located below the flour accommodating basin and having a flour sifting trough with flour sifting holes at the bottom. A transmission device rotatably drives a rotary brush shaft provided in the flour sifting tank so that helically distributed silicone brushes are driven to rotate and brush the flour sifting holes. A driving box drives the transmission device. A fine flour basin is located below the flour sifting tank, and receives fine flour in a flour mixture being sifted through the flour sifting holes. A coarse flour basin is located at the rear end of the fine flour basin, and receives coarse flour, after being sifted by the flour sifting tank, from a flour discharge passage located on one side of the flour sifting tank.

### CROSS-REFERENCE TO RELATED APPLICATIONS

This application is a 371 National Phase of PCT/EP2022/086440, filed Dec. 16, 2022, which claims priority to CN Application No. 202123269840.2, filed Dec. 22, 2021 and CN Application No. 202222566490.4, filed Sep. 26, 2022, all of which are incorporated herein by reference as if fully set forth.

### TECHNICAL FIELD

The present invention relates to a flour sifting device, and in particular to a flour sifting device for sifting flour in coarse flour and fine flour.

### BACKGROUND

The diameter of the flour sifting holes in a prior flour sifting machine available on the current market is usually very small. The flour sifting holes can separate particles with large diameters and sift fine flour. However, the smaller the diameter of the flour sifting holes, the more easily the flour sifting holes are clogged. The sifting efficiency of the flour sifting machine heavily depends on whether or not the flour sifting holes are clogged. If the flour sifting holes are clogged, it is difficult to improve the sifting effect. The clogging of the flour sifting holes is usually cleared by use of reciprocal motions of a brush on the flour sifting holes. However, when the brush makes reciprocal motions on the flour sifting holes, flour sifting actions will usually be dis-continuous, and thus the flour sifting holes are easily clogged.

A bread sifting table is disclosed in U.S. Pat. No. 9,451,789B2. A food coating apparatus includes a drum assembly with an input end for receiving coating material, i.e. bread crumbs, and food product, a hollow body for mixing the coating material and the food product to form coated food product and used coating material, and an output end for allowing coated food product and used coating material to exit the drum assembly. Used coating material is passed into a sifter which separates the used coating material into refuse and reusable coating material. The sifter has a sifter screen with a rotatable sifter brush. The sifter brush includes a core and a plurality of bristles which extend from the core in a helical pattern and are made out of a flexible material such as, for example, nylon. This arrangement is prone to clogging. Depending on the size of the holes of the sifter screen, the transport by the helical brushes can be too fast so that reusable fine coating material has not enough time to fall through the sifter screen and is finally dis-carded in the receptacle for the refuse coating material.

### SUMMARY

The objective of the present invention is to at least provide an improved sifting device, which reduces the problem of clogging of flour sifting holes and improves the sifting efficiency and in particular provides improved accuracy and efficiency of flour sifting.

According to a first aspect, the present invention provides a flour sifting device, and the flour sifting device comprises:
a flour accommodating basin, the flour accommodating basin having a first flour outlet and the first flour outlet being provided at the centre of the bottom of the flour accommodating basin;
a flour sifting tank, the flour sifting tank being located below the flour accommodating basin and the bottom of the flour sifting tank having flour sifting holes;
a transmission device, the transmission device being used to drive the flour sifting tank to run, the transmission device being connected to a rotary shaft joint of a rotary brush shaft and driving the rotary brush shaft to rotate, the rotary brush shaft driving discrete flexible brushes on the rotary brush shaft to rotate, the flexible brushes being distributed helically and evenly along the rotary brush shaft, the flexible brushes rotating to brush the flour sifting holes at the bottom of the flour sifting tank and the rotary brush shaft rotating to drive the flexible brushes to rotate in a direction;
a fine flour basin, the fine flour basin being located below the flour sifting tank and fine flour in a flour mixture being sifted through the flour sifting holes of the flour sifting tank and falling into the fine flour basin; and
a coarse flour basin, the coarse flour basin being located at the rear end of the fine flour basin and coarse flour sliding into the coarse flour basin from a flour discharge passage located on one side of the flour sifting tank after being sifted by the flour sifting tank.

The helical arrangement separate flexible brushes improve the sifting efficiency of the flour sifting device. The overall service life of the device is prolonged, and the working efficiency is improved.

Flour in the context of the present invention is to be broadly understood to refer in particular to all kind of food coating material, including breadcrumbs, cereal flour, cheese flakes, spices and so on.

Preferably, the flexible brushes are made of silicone. This material is hygienic, durable and easily be cleaned.

Preferably, the flexible brushes are in the form of discrete paddles with gaps between in circumferential direction adjacent paddles. This allows coating material enough time during travel through the sifting tank.

Preferably, the brushes are arranged in axial direction of the brush shaft in columns. The columns are in circumferential direction evenly distributed around the brush shaft. Where there are n columns with brushes, the angle between circumferentially adjacent columns is 360°/n. Preferably n is at least three. More preferably, the rotating brush has four columns of brushes arranges at 90° angles around the brush shaft.

Preferably, the brushes are toothed edge at their radially outer end. This improves the transport, reduces clogging even more and improves the sifting efficiency.

Preferably, the brushes are inclined with respect to radial planes by a tilt angle. The tile angle may be between 10° and 45°. The improves the transport and the sifting efficiency.

Preferably there are stops in the form of baffle discs arranged in axial direction between groups of brushes. Without limiting the invention on this, there can be for example three axially displaced stops three, dividing the brushes in four groups. The stops reduce the transport of the flour along the sifting tank and thus increases the sifting efficiency.

According to a second aspect, the present invention provides a flour sifting device, and the flour sifting device comprises a flour sifting tank, the flour sifting tank comprising a tank cover and a tank body, the tank cover being provided at the top of the tank body, and a handle being also provided at the centre of the top of the tank; a rotary brush shaft, the rotary brush shaft being provided in the tank body, a plurality of toothed silicone brushes and a plurality of notched baffles being provided on the rotary brush shaft, and each baffle being provided between the toothed silicone brushes; a flour sifting trough, the flour sifting trough being provided between the middle and the bottom of the tank body and a plurality of flour sifting holes being provided in the flour sifting trough. Preferably, a material receiving port is provided at one end of the tank cover, the material receiving port being configured to be in the shape of a vertical funnel, and pencil-like grids being provided at the top of the material receiving port.

The flour sifting device according to the second aspect has at least the following advantageous effects: Toothed silicone brushes and baffles are provided on the rotary brush shaft for the flour sifting device. When rotating, the rotary brush shaft drives the toothed silicone brushes and the baffles to rotate. The toothed silicone brushes brush the flour sifting holes in the flour sifting trough to clear the flour mixture on the flour sifting holes. When the flour mixture is moved quickly by the toothed silicone brushes, the baffles can effectively slow down the movement of the flour mixture so that high-quality flour will not be brushed away easily. Thus, the accuracy and efficiency of flour sifting are improved.

It is to be understood that the flour sifting trough in the context of the invention can be any kind of sifter screen.

According to an embodiment, first installation parts and second installation parts for fixing the toothed silicone brushes and the baffles are further provided on the rotary brush shaft, the axes of the first installation parts and the axes of the second installation parts are perpendicular to each other, and a first included angle is formed between the first installation parts and/or the second installation parts and the axis of the rotary brush shaft. The efficiency of flour sifting can be improved.

According to an embodiment, the distance between the axes of two adjacent first installation parts or two adjacent second installation parts is a first distance, and the distance between the axes of a first installation part and a second installation part adjacent to each other is a second distance, wherein the first distance is twice the second distance. The efficiency of flour sifting is further improved.

According to an embodiment, a third installation part is provided on the baffle, a first installation through-hole is provided in the third installation part, a second installation through-hole corresponding to the third installation part is provided in the first installation part and the second installation part, and a bolt is threaded through the first installation through-hole and the second installation through-hole to install the baffle on the rotary brush shaft. After the baffle is firmly installed onto the rotary brush shaft by use of the bolt, the impact of flour on the baffle at the time of rotation will not easily loosen the baffle.

According to an embodiment, an installation slot is provided in the toothed silicone brushes, and the first installation part and the second installation part are inserted into the installation slot to install the toothed silicone brushes on the rotary brush shaft. Thus, it is more convenient to remove the toothed silicone brushes.

According to an embodiment, the flour sifting trough further comprises an arc-shaped bottom surface, two vertical side surfaces extending upward from the two sides of the arc-shaped bottom surface respectively, and snap-on portions extending horizontally outward from the top of the vertical side surfaces and keeping the flour sifting trough snapped on the flour sifting tank. Thus, it is simpler and more convenient to remove and install the flour sifting tank.

In a third aspect, the present invention provides a flour coating table and the flour coating table comprises the flour sifting device as described in the first aspect.

The flour coating table according to embodiments of the invention has at least the following advantageous effects: Toothed silicone brushes and baffles are provided on the rotary brush shaft for the flour sifting device. When rotating, the rotary brush shaft drives the toothed silicone brushes and the baffles to rotate. The toothed silicone brushes brush the flour sifting holes in the flour sifting trough to clear the flour mixture on the flour sifting holes. When the flour mixture is moved quickly by the toothed silicone brushes, the baffles can effectively slow down the movement of the flour mixture so that high-quality flour will not be brushed away easily. Thus, the accuracy and efficiency of flour sifting are improved.

The flour coating table according to embodiments of the third aspect further comprises: a rack; rollers, the rollers being installed at the bottom of the rack and used to drive the flour coating table to move; a flour accommodating basin, a first flour outlet being provided at the bottom of the flour accommodating basin; a driving box, the driving box being used to drive a transmission device, and the transmission device being connected with the flour sifting device; a fine flour basin, the fine flour basin being located below the flour sifting device and used to collect sifted fine flour; a coarse flour basin, the coarse flour basin being located on one side below the flour sifting device and far away from the first flour outlet and used to collect sifted coarse flour. Flour falls from the first flour outlet of the flour accommodating basin and is sifted by the flour sifting device. Then, fine flour falls into the fine flour basin and coarse flour falls into the coarse flour basin. Thus, a flour mixture can be sorted and collected.

According to an embodiment, the transmission device further comprises: a gear motor, a delivery wheel, a transmission shaft, an elastic linking rod and a spring, the elastic linking rod slides on the transmission shaft, and the elastic linking rod can automatically return to the original position under the action of the spring, and the transmission device drives the rotary brush shaft in the flour sifting device to rotate and move to realise successive reciprocating flour sifting of the flour sifting device. Thus, the efficiency and accuracy of flour sifting are higher.

According to an embodiment, the gear motor drives the flour sifting device to sift flour via the delivery wheel.

The above described features can be combined in any way. Further advantageous refinements are described below and in the claims.

### BRIEF DESCRIPTION OF THE DRAWINGS

Further advantageous features and characteristics of the invention will emerge from the following description of exemplary embodiments on the basis of the figures, in which:

FIG. 1 is a perspective view of the flour sifting device according a first embodiment;

FIG. 2A is a front view of the flour sifting device (with the rack and moving rollers removed) according the first embodiment;

FIG. 2B is a half-cutaway view of FIG. 2A;

FIG. 3 is a top view of the flour sifting tank and the transmission device;

FIG. 4 is a top view of the rotary brush shaft and the silicone brushes;

FIG. 5 is an exploded view of the flour sifting tank;

FIG. 6 is a side view of the flour sifting tank;

FIG. 7 is a perspective view of the rotary brush shaft and the transmission device;

FIG. 8 is a partial perspective view of a flour sifting device and flour coating table according to a second embodiment.

FIG. 9 shows the structure of the rotary brush shaft of the flour sifting device shown in FIG. 8.

FIG. 10 shows a partial structure of the rotary brush shaft shown in FIG. 9.

FIG. 11 shows the structure of a baffle disc on the rotary brush shaft shown in FIG. 9.

FIG. 12 shows the structure of a toothed silicone brush on the rotary brush shaft shown in FIG. 9.

FIG. 13 is a top view of the flour sifting device of the second embodiment.

FIG. 14 is a left view of the flour coating table of the second embodiment.

FIG. 15 is a top view of the flour coating table of the second embodiment.

### DETAILED DESCRIPTION

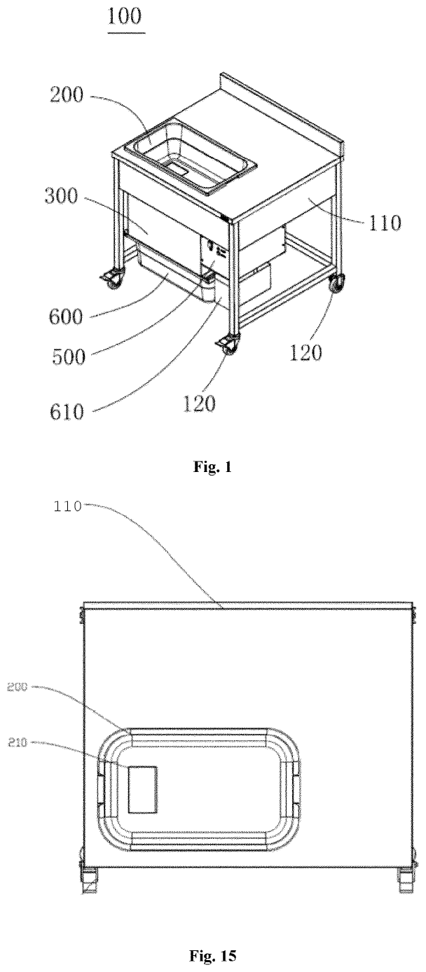

Referring to FIGS. 1, 2A, 2B and 3, according to one embodiment, a flour sifting device 100 comprises: a rack 110; a flour accommodating basin 200, the flour accommodating basin 200 having a first flour outlet 210 at the bottom; a flour sifting tank 300, the flour sifting tank 300 being located below the flour accommodating basin 200, and a flour sifting trough 340 provided with flour sifting holes at the bottom being accommodated in the flour accommodating tank 300; a transmission device 400, the transmission device 400 being used to drive a rotary brush shaft 310 that is set in the flour sifting tank 300 to rotate, the rotary brush shaft 310 being provided with silicone brushes 316 helically distributed in space, and the rotary brush shaft 310 rotating to drive the silicone brushes 316 to rotate in a direction and brush the flour sifting holes; a driving box 500, the driving box 500 being used to drive the transmission device 400; a fine flour basin 600, the fine flour basin 600 being located below the flour sifting tank 300 and fine flour in a flour mixture being sifted through the flour sifting holes of the flour sifting tank 300 and falling into the fine flour basin 600; and a coarse flour basin 610, the coarse flour basin 610 being located below the flour sifting tank 300 on one side far away from the first flour outlet 210, and coarse flour, after being sifted by the flour sifting tank 300, sliding into the coarse flour basin 610 from a flour discharge passage 330 located on one side of the flour sifting tank 300.

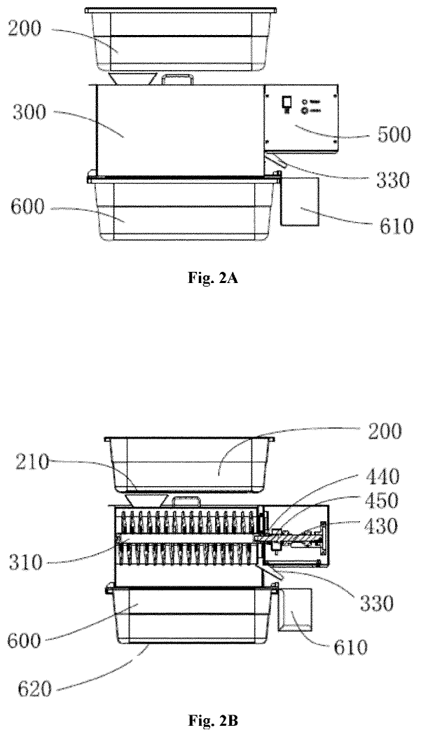

It can be seen from FIG. 2B that the flour sifting process is as follows: A flour mixture is discharged from the first flour outlet 210 of the flour accommodating basin 200, falls into the flour sifting tank 300 and is sifted by the flour sifting tank 300, fine flour passes through the flour sifting holes (not shown), falls into the fine flour basin 600 and is discharged from the flour discharge port 602 of the fine flour basin 600, and coarse flour is sifted by the flour sifting tank 300, discharged from the flour discharge passage 330 and falls into the coarse flour basin 610. This technical feature further improves the sifting efficiency.

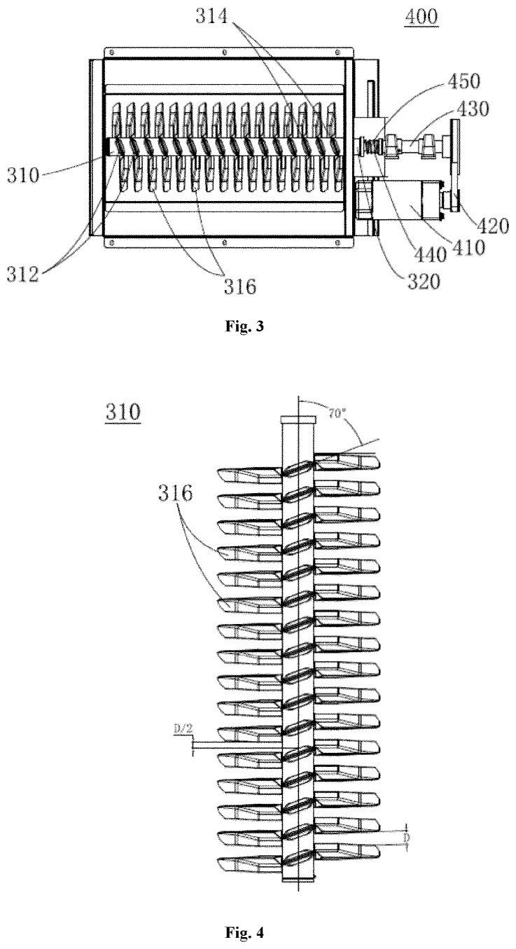

Referring to FIG. 3, according to one embodiment of the present application and claim 1, the flour sifting device 100 is characterised in that a group of first installation parts 312 and a group of second installation parts 314 are provided on the rotary brush shaft 310, the axes of the first installation parts 312 and the second installation parts 314 are perpendicular to each other, and the first installation parts 312 and the second installation parts 314 are all used to fix the silicone brushes 316. Thus, the rotary brush shaft 310 rotates steadily and evenly during rotation, and the service life of the device is prolonged.

Referring to FIG. 4, according to one embodiment of the present application, the distance between the axes of two adjacent first installation parts 312 and second installation parts 314 is D, and the distance between the axes of a first installation part 312 and a second installation part 314 adjacent to each other is D/2. This technical feature causes a thrust moving in the delivery direction to be generated when the rotary brush shaft 310 rotates, and the thrust replaces the prior conveyor belt. Thus, the structure is optimized and the cost is saved. The angle difference between the axes of a first installation part 312 and a second installation part 314 adjacent to each other is 90°. This technical feature makes the force applied on the rotary brush shaft 310 uniform and, overall, the rotary brush shaft 310 receives distributed forces, so the service life of the rotary brush shaft 310 is prolonged.

Referring to FIG. 4, according to one embodiment of the present application, an included angle of 70° is formed between the axes of the silicone brushes 316 and the rotary brush shaft 310, and the silicone brushes 316 can be detached and replaced. The included angle is 70°, which increases the area each silicone brush can cover, and meanwhile, a thrust to-ward the delivery direction is generated to replace the prior conveyor belt, so the structure is optimized and the cost is saved. The silicone brushes 316 can be detached and replaced so that a damaged silicone brush can be replaced at any time, without the need to replace all the silicone brushes 316, leading to much saving of time and improved productivity and economic benefits.

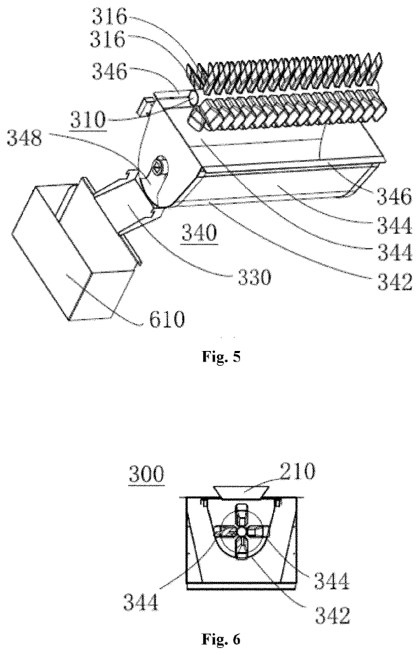

Referring to FIGS. 4 and 5, according to one embodiment of the present application, the radial angle between adjacent silicone brushes 316 is a right angle, and the silicone brushes 316 brush the flour sifting holes four times for each revolution of the rotary brush shaft 310. This technical feature improves the efficiency of brushing flour. The efficiency will be obviously lower if the flour sifting holes are brushed three times for each revolution of the rotary brush shaft; a group of silicone brushes needs to be added if the flour sifting holes are brushed five times for each revolution of the rotary brush shaft, and thus, the limited space in the flour sifting tank 300 will be further reduced, and, of course, the volume of the flour mixture which can be accommodated will be reduced.

Referring to FIGS. 5 and 6, according to one embodiment of the present application, the flour sifting trough 340 comprises: an arc-shaped bottom surface 342, the radius of the arc-shaped bottom surface 342 matching the distance from the outermost end of the silicone brushes 316 to the centre of the rotary brush shaft 310; two vertical side surfaces 344 extending upward from the two sides of the arc-shaped bottom surface 342 respectively; snap-on portions 346 extending horizontally outward from the two vertical side surfaces 344, wherein the snap-on portions 346 of the flour sifting trough 340 are installed in the flour sifting tank 300. It can be seen from FIG. 6 that the silicone brushes 316 run counter clockwise.

This technical feature ensures that fine flour can be more fully squeezed through the flour sifting holes at the bottom of the flour sifting tank 300. As a result, the sifting efficiency is further improved.

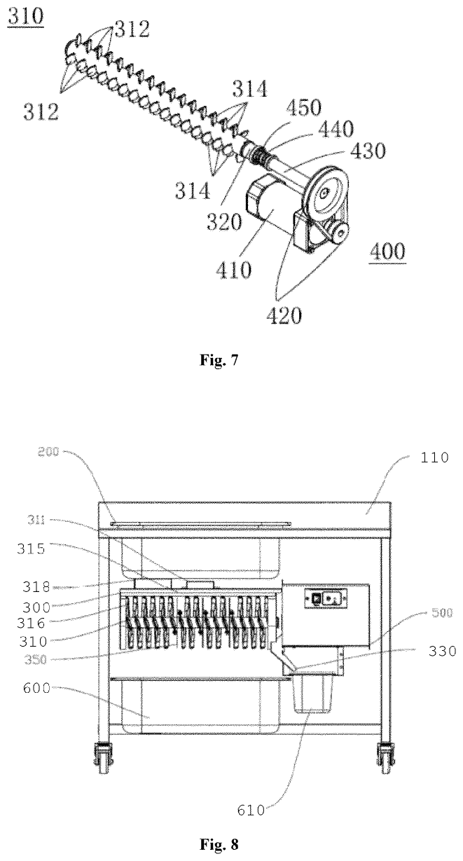

Referring to FIG. 7, according to one embodiment of the present application, the transmission device 400 comprises: a gear motor 410, a delivery wheel 420, a transmission shaft 430, an elastic linking rod 440, and a spring 450, wherein the elastic linking rod 440 can slide on the transmission shaft 430. The gear motor 410 drives the rotary brush shaft 310 to rotate via the delivery wheel 420. This technical feature ensures that there will not be excessive torque accumulated on the elastic linking rod 440. Thus, the overall service life of the flour sifting device is prolonged.

A second embodiment of a flour sifting device is described with reference to FIGS. 8 to 12. As in the embodiment before, the flour sifting device 100 in FIG. 8 comprises a flour sifting tank 300, a rotary brush shaft 310, a flour sifting trough and a material receiving port 318. The flour sifting tank 300 comprises a tank body 313 and a tank cover 315 at the top, and a handle 311 is provided at the centre of the tank cover 315. With the aid of the handle 311, the tank cover 315 can be lifted up to separate the tank cover 315 from the tank body 313. The rotary brush shaft 310 is provided in the tank body 313, a plurality of toothed silicone brushes 316 and baffle discs 350 are provided on the rotary brush shaft 310, a notch is cut in the baffle discs 350, and the baffle discs 350 are provided between the toothed silicone brushes 316. The flour sifting trough is provided between the middle and the bottom of the tank body 313 and a plurality of flour sifting holes (not shown) are provided in the flour sifting trough. The material receiving port 318 is in the shape of a vertical funnel, pencil-like grids 319 are provided at the top of the material receiving port, and the material receiving port is provided at one end of the tank cover 315. It can be understood that the size and the shape of the pencil-like grids may be arbitrarily adjusted according to the number and positions of pencil-like grids 319 and will not be restricted here.

Specifically, when the rotary brush shaft 310 rotates, the toothed silicone brushes 316 and the baffle discs 350 installed on the rotary brush shaft 310 are also driven to rotate. The toothed silicone brushes 316 can brush flour sifting holes in the flour sifting trough to clear the flour mixture which clogs the flour sifting holes. In addition, when the toothed silicone brushes 316 rotate, the flour mixture will also move. At this time, the baffle disc 350 can block the movement of the flour mixture and slow down the movement of the flour mixture so that the flour mixture is brushed more times and more high-quality flour is sifted. Thus, the accuracy and efficiency of flour sifting are improved and high-quality flour is prevented from being sifted away.

Specifically, since the flour sifting trough is provided between the middle and the bottom of the tank body 313, the flour mixture on the toothed silicone brushes 316 will not leak or be blown out of the upper part or the top of the tank body 313 when the toothed silicone brushes 316 rotate.

It can be understood that the material receiving port 318 in the shape of a vertical funnel reduces the accumulation or overflow of flour at the material receiving port 318 when the flour mixture falls. In addition, it is unnecessary to clear accumulated flour by hand. Thus, it is more convenient to clear flour.

It can be understood that when the toothed silicone brushes 316 rotate to brush the flour mixture, the flour mixture will not completely be swept and some will pass through the teeth. Thus, the movement of the flour mixture is slowed down.

It can be understood that a gap or a through-hole allowing the flour mixture to pass through is reserved in the baffle discs 350. The specific structure of the baffle discs may be designed according to the actual situation and will not be defined here.

It can be understood that a plurality of toothed silicone brushes 316 may be provided. The number of toothed silicone brushes may be designed as required and will not be defined here.

It can be understood that two, three or more baffle discs 350 may be provided. The number of baffle discs may be designed as required and will not be defined here.

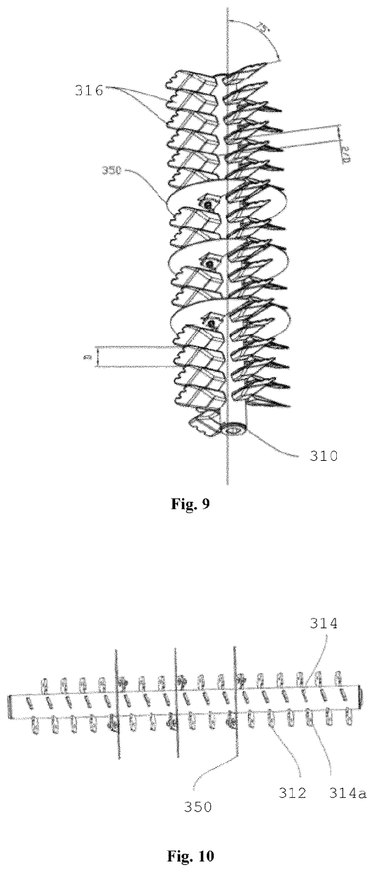

See FIGS. 9 and 10. It can be understood that the toothed silicone brushes 316 and the baffle discs 350 are fixed through the first installation parts 312 and the second installation parts 314 on the rotary brush shaft 310, the axes of the first installation parts 312 and the second installation parts 314 are perpendicular to each other, and a first included angle is formed between the first installation parts 312 and/or the second installation parts 314 and the axis of the rotary brush shaft 310. The distance between the axes of two adjacent first installation parts 312 or two adjacent second installation parts 314 is a first distance D, the distance between the axes of a first installation part 312 and a second installation part 314 adjacent to each other is a second distance D/2. It can be understood that the second distance may be D/3 or D/4, and it may be designed as required and will not be defined here.

Specifically, the axes of the first installation parts 312 and the second installation parts 314 are perpendicular to each other to form an angle of 90°, and the toothed silicone brushes 316 fixed on the rotary brush shaft brush flour sifting holes four times for each revolution of the rotary brush shaft 310. Thus, the efficiency of brushing flour is improved. It can be understood that the angle between the axes of the first installation parts 312 and the second installation parts 314 may be an angle other than a right angle so that the toothed silicone brushes 316 can brush flour sifting holes more than four times for each revolution of the rotary brush shaft 310. The angle between the axes of the first installation parts 312 and the second installation parts 314 will not be defined here.

Specifically, the first included angle formed between the first installation parts 312 and/or the second installation parts 314 and the axis of the rotary brush shaft 310 may be 75°. In this way, while the coverage area of the toothed silicone brushes 316 is increased, a thrust in the delivery direction is generated, without the need to use a conveyor belt.

It can be understood that the first included angle formed between the first installation parts 312 and/or the second installation parts 314 and the axis of the rotary brush shaft 310 may be adjusted according to the required coverage area and thrust and will not be defined here.

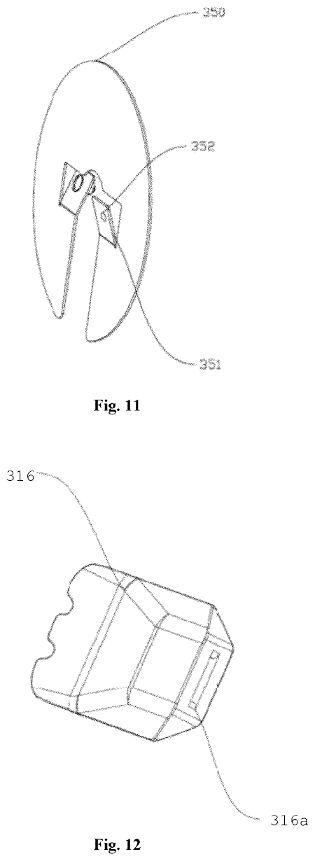

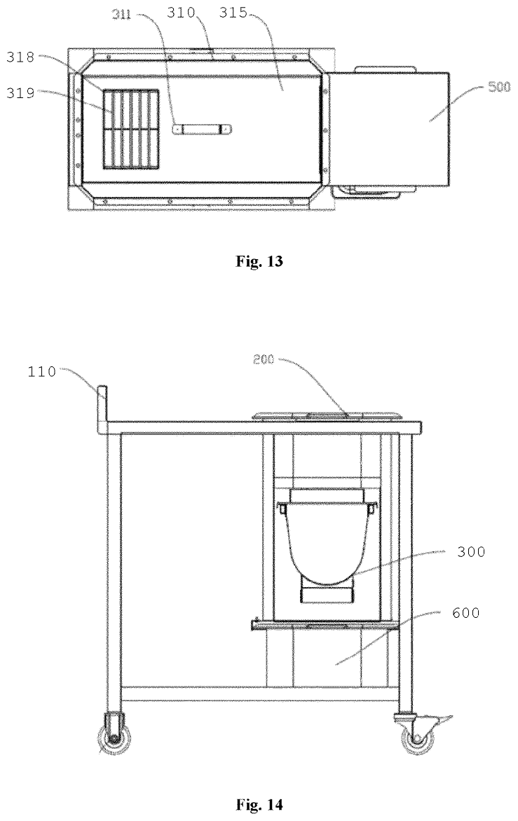

See FIGS. 10 and 11. A third installation part 351 is provided on the baffle disc 350, a first installation through-hole 352 is provided in the third installation part 351, a second installation through-hole 314a corresponding to the third installation part 351 is provided in the first installation part 312 and the second installation part 314, and a bolt is threaded through the first installation through-hole 352 and the second installation through-hole 314 a to install the baffle disc 350 on the rotary brush shaft 310. Specifically, to install the baffle disc 350, align the first installation through-hole 352 in the third installation part 351 on the baffle disc 350 with the second installation through-hole 314a in the first installation part 312 or the second installation part 314, and then thread a bolt through the first installation through-hole 352 and the second installation through-hole 314a and tighten it so that the baffle disc 350 is stably fixed onto the rotary brush shaft 310.

It can be understood that besides using a bolt to fix the baffle disc 350 onto the rotary brush shaft 310, the third installation part 312 on the baffle disc 350 may be welded onto the first installation part 312 and/or the second installation part 322 so that the baffle disc 350 is more steadily fixed onto the rotary brush shaft 310.

Further, besides welding the third installation part 312 on the baffle on the first installation part 312 and/or the second installation part 322, the baffle disc 350 may be directly welded onto the rotary brush shaft 310.

See FIGS. 10 and 12. An installation slot 316a is provided at the bottom of the toothed silicone brushes, and the first installation part 312 and the second installation part are inserted into the installation slot 316a to install the toothed silicone brushes 316 onto the rotary brush shaft 310. Specifically, the shape of the installation slot 316a corresponds to the shapes of the first installation part 312 and the second installation part 314, and the first installation part 312 and the second installation part 314 can be completely covered when the first installation part 312 and the second installation part 314 are inserted. When a toothed silicone brush 316 is damaged, the damaged toothed silicone brush 316 may be removed and then a new toothed silicone brush 316 may be inserted. Thus, the removal and installation are more convenient.

See FIG. 14. The bottom of the flour sifting trough is an arc-shaped bottom surface, two vertical side surfaces extend from the two sides of the arc-shaped bottom surface, respectively, and snap-on portions extend horizontally from the top of the two vertical side surfaces to snap the flour sifting trough onto the flour sifting tank 300. Specifically, to install the flour sifting trough, with the bottom of the flour sifting trough facing the flour sifting tank, place the flour sifting trough into the flour sifting tank 300 until the snap-on portions snap onto the flour sifting tank 300.

See FIGS. 1, 8, 14 and 15. The flour coating table of the second embodiment comprises the flour sifting device 100 in the above-mentioned embodiment and thus at least has all advantageous effects brought about by the technical solution in the above-mentioned embodiment.

The flour coating table of the second embodiment further comprises: a rack 110, rollers 120, a flour accommodating basin 200, a driving box 500, a fine flour basin 600 and a coarse flour basin 610. The rollers 120 are installed at the bottom of the rack 110, and the rollers 120 are further provided with a locking device. A first flour outlet 210 is provided at the bottom of the flour accommodating basin 200. Specifically, the flour accommodating basin 200 is used to accommodate a flour mixture, and the flour mixture falls into the flour sifting tank 300 from the first flour outlet 210 at the bottom. The driving box 500 drives the transmission device and the transmission device is connected with the flour sifting device 100. Specifically, when the driving box 500 drives the transmission device to move, the flour sifting device 100 connected with the transmission device also moves together. The fine flour basin 600 is located below the flour sifting device 100 and is used to collect fine flour. Specifically, when the toothed silicone brushes 316 in the flour sifting tank 300 brush flour sifting holes, fine flour and coarse flour are separated, fine flour passes through flour sifting holes and falls, and the fine flour basin 600 collects fine flour sifted by the flour sifting tank 300. The coarse flour basin 610 is located on one side below the flour sifting device 100 and far away from the first flour outlet 210 and is used to collect coarse flour. Specifically, a flour discharge passage 330 is further provided on one side far away from the material receiving port 318 at the bottom of the flour sifting device 100. When the toothed silicone brushes 316 in the flour sifting tank 300 brush flour sifting holes, fine flour and coarse flour are separated. Since coarse flour has a larger diameter and cannot pass through flour sifting holes, coarse flour moves towards the flour discharge passage 330. After moving to the flour discharge passage 330, coarse flour slides into the coarse flour basin 610 from the flour discharge passage 330, and thus, the coarse flour basin serves the function of collecting coarse flour.

See FIG. 8. The transmission device further comprises a gear motor 410, a delivery wheel 420, a transmission shaft 430, an elastic linking rod 440 and a spring 450. The elastic linking rod 440 may slide on the transmission shaft 430. When the elastic linking rod 440 slides to a position, the elastic linking rod 440 will return to the original position under the action of the spring 450. Specifically, the spring 450 and the elastic linking rod 440 are put on the transmission shaft 430 and the spring 450 abuts between the elastic linking rod 440 and the boss of the transmission shaft 430. When sliding on the transmission shaft 430, the elastic linking rod 440 compresses the spring 450. When the elastic linking rod 440 slides to a certain position, the force of the spring 450 is large enough to bounce back the elastic linking rod 440 so that the elastic linking rod 440 is returned to its position. The gear motor 410 drives the flour sifting device 100 to sift flour via the delivery wheel 420. Specifically, the transmission shaft 430 is connected with the rotary brush shaft 310 in the flour sifting tank 300 via the elastic linking rod 440, and the axis centre of the delivery wheel 420 is connected with the transmission shaft 430. When running, the gear motor 410 drives the delivery wheel 420 to rotate, the delivery wheel 420 drives the transmission shaft 430 to rotate, and the transmission shaft 430 further drives the rotary brush shaft 310 to rotate. Thus, the toothed silicone brushes 316 on the rotary brush shaft 310 can rotate to brush the flour sifting holes to realise the function of flour sifting.

Specifically, the transmission device is installed in the driving box 500, a circuit board for controlling the running of the transmission device is further provided on the transmission device, and a power button for controlling the running of the transmission device is provided on the outer wall of the driving box 500 and is connected with the circuit board to control start and stop of the transmission device.

1. A flour sifting device (100), comprising:
a flour accommodating basin (200) having a first flour outlet (210) at a bottom of the flour accommodating basin (200);
a flour sifting tank located below the flour accommodating basin (200), and the flour sifting tank (300) being provided with a flour sifting trough (340) with flour sifting holes at a bottom thereof;
a transmission device (400) adapted to drive a rotary brush shaft (310) that is set in the flour sifting tank (300) to rotate, the rotary brush shaft (310) being provided with discrete flexible brushes (316) helically distributed in space, and the rotary brush shaft (310) rotating to drive the discrete flexible brushes (316) to rotate in a direction and brush the flour sifting holes;
a fine flour basin (600) located below the flour sifting tank (300), and fine flour in a flour mixture being sifted through the flour sifting holes of the flour sifting tank (300) being adapted to fall into the fine flour basin (600); and
a coarse flour basin (610) located on a side away from the first flour outlet (210), and coarse flour, after being sifted by the flour sifting tank (300), being adapted to slide into the coarse flour basin (610) from a flour discharge passage (330) located on one side of the flour sifting tank (300).

2. The flour sifting device according to claim 1, wherein the discrete flexible brushes (316) are made of silicone.

3. The flour sifting device according to claim 1, wherein the discrete flexible brushes (316) comprise discrete paddles with gaps between in circumferential direction between adjacent ones of the paddles.

4. The flour sifting device according to claim 1, wherein discrete flexible brushes (316) are arranged in an axial direction of the brush shaft (310) in columns, wherein the columns are evenly distributed in a circumferential direction around the brush shaft (316).

5. The flour sifting device according to claim 1, wherein the discrete flexible brushes (316) have a toothed edge at radially outer ends thereof.

6. The flour sifting device according to claim 1, wherein the discrete flexible brushes (316) are inclined with respect to radial planes by a tilt angle.

7. The flour sifting device according to claim 1, wherein the rotary brush shaft (310) carries stops formed as baffle discs arranged in an axial direction between groups of the brushes.

8. The flour sifting device (100) according to claim 1, wherein a group of first installation parts (312) and a group of second installation parts (314) are provided on the rotary brush shaft (310), axes of the first installation parts (312) and the second installation parts (314) are perpendicular to each other, and the first installation parts (312) and the second installation parts (314) fix the silicone brushes (316) to the rotary brush shaft.

9. The flour sifting device (100) according to claim 8, wherein a distance between the axes of two adjacent ones of the first installation parts (312) or ones of the second installation parts (314) is D, and a distance between the axes of one said first installation part (312) and one said second installation part that are adjacent to each other is D/2.

10. The flour sifting device (100) according to claim 8, wherein an angle difference between the axes of one said first installation part (312) and one said second installation part (314) that are adjacent to each other is 90°.

11. The flour sifting device (100) according to claim 1, wherein an included angle of 70° is formed between axes of the silicone brushes (316) and the rotary brush shaft (310), and the silicone brushes (316) are detachable and replaceable.

12. The flour sifting device (100) according to claim 1, wherein a radial angle between adjacent ones of the silicone brushes (316) is 90°, and the silicone brushes (316) brush the flour sifting holes four times for each revolution of the rotary brush shaft (310).

13. The flour sifting device (100) according to claim 1, wherein or the flour sifting trough (340) comprises: an arc-shaped bottom surface (342), a radius of the arc-shaped bottom surface (342) matching a distance from an outermost end of the discrete flexible brushes (316) to a centre of the rotary brush shaft (310); two vertical side surfaces (344) extending upward from two sides of the arc-shaped bottom surface (342) respectively; snap-on portions (346) extending horizontally outward from the two vertical side surfaces (344), the snap-on portions (346) of the flour sifting trough (340) being installed in the flour sifting tank (300).

14. The flour sifting device (100) according to claim 1, wherein the transmission device (400) comprises a gear motor (410), a delivery wheel (420), a transmission shaft (430), an elastic linking rod (440) and a spring (450), and the elastic linking rod (440) is slidable on the transmission shaft (430).

15. The flour sifting device (100) according to claim 14, wherein the elastic linking rod (440) is adapted to automatically return to an original position under action of the spring (450).

16. The flour sifting device (100) according to claim 14, wherein the gear motor (410) drives the rotary brush shaft (310) to rotate via the delivery wheel (420).

17. The flour sifting device (100) according to claim 1, further comprising a rack (110) and a driving box (500), the driving box (500) being adapted to drive the transmission device (400).

18. A flour sifting device, comprising:
a flour sifting tank, comprising a tank cover and a tank body, the tank cover being at a top of the tank body, and a handle at a centre of a top of the tank cover;
a rotary brush shaft, the tank body, a plurality of toothed silicone brushes and a plurality of notched baffles on the rotary brush shaft, and each of the baffles being between the toothed silicone brushes;
a flour sifting trough, between a middle and a bottom of the tank body, and a plurality of flour sifting holes in the flour sifting trough.

19. The flour sifting device according to claim 18, further comprising a material receiving port, one end of the tank cover, the material receiving port being configured with a vertical funnel shape, and pencil-type grids being provided at s top of the material receiving port.

20. The flour sifting device according to claim 18, further comprising first installation parts and second installation parts for fixing the toothed silicone brushes and the baffle discs on the rotary brush shaft, axes of the first installation parts and axes of the second installation parts are perpendicular to each other, and a first included angle is formed between the first installation parts and/or the second installation parts and an axis of the rotary brush shaft.

21. The flour sifting device according to claim 20, wherein a distance between the axes of two adjacent ones of the first installation parts or two adjacent ones of the second installation parts is a first distance, a distance between the axes of one said first installation part and one said second installation part that are adjacent to each other is a second distance, and the first distance is twice the second distance.

22. The flour sifting device according to claim 20, further comprising third installation part on the baffle, a first installation through-hole is provided in the third installation part, a second installation through-hole corresponding to the third installation part is provided in the first installation part and the second installation part, and a bolt is threaded through the first installation through-hole and the second installation through-hole to install the baffle on the rotary brush shaft.

23. The flour sifting device according to claim 20, further comprising an installation slot in the toothed silicone brushes, and the first installation part and the second installation part are inserted into the installation slot to install the toothed silicone brushes on the rotary brush shaft.

24. The flour sifting device according to claim 18, wherein the flour sifting trough further comprises an arc-shaped bottom surface, two vertical side surfaces extending upward from two sides of the arc-shaped bottom surface respectively, and snap-on portions extending horizontally outward from a top of the vertical side surfaces and keeping the flour sifting trough snapped on the flour sifting tank.

25. A flour coating table, comprising the flour sifting device as claimed in claim 1.

26. The flour coating table according to claim 25, further comprising:
a rack; rollers installed at a bottom of the rack and used to drive the flour coating table to move;
a flour accommodating basin, a first flour outlet being at a bottom of the flour accommodating basin;
a driving box, the driving box that is adapted to drive a transmission device, and the transmission device being connected with the flour sifting device;
a fine flour basin located below the flour sifting device and being adapted to collect sifted fine flour;
a coarse flour basin located on one side below the flour sifting device, away from the first flour outlet, and being adapted to collect sifted coarse flour.

27. The flour coating table according to claim 26, wherein the transmission device further comprises a gear motor, a delivery wheel, a transmission shaft, an elastic linking rod and a spring, the elastic linking rod slides on the transmission shaft, and the elastic linking rod automatically returns to an original position under action of the spring.

28. the flour coating table according to claim 27, wherein the gear motor drives the flour sifting device to sift flour via the delivery wheel.
